(19) United States
(12) Patent Application Publication
(10) Pub. No.: US 2025/0358380 A1
(43) Pub. Date: Nov. 20, 2025

(54) IMAGE READING DEVICE, IMAGE FORMING APPARATUS, AND IMAGE READING METHOD

(71) Applicants: Atsuki NISHIGO, Kanagawa (JP); Hironori SASAKI, Kanagawa (JP)

(72) Inventors: Atsuki NISHIGO, Kanagawa (JP); Hironori SASAKI, Kanagawa (JP)

(73) Assignee: Ricoh Company, Ltd., Ohta-ku, Tokyo (JP)

(21) Appl. No.: 19/185,545

(22) Filed: Apr. 22, 2025

(30) Foreign Application Priority Data
May 16, 2024 (JP) 2024-080310
Jan. 10, 2025 (JP) 2025-004075

(51) Int. Cl. H04N 1/40; G03G 15/22; H04N 1/028; H04N 1/031

(52) U.S. Cl. CPC H04N 1/40068; G03G 15/228; H04N 1/02865; H04N 1/031

(57) ABSTRACT

An image reading device includes a light receiving array including multiple light receiving elements arrayed in a main scanning direction, the multiple light receiving elements to perform photoelectrical conversion for corresponding pixels and output analog data, respectively; multiple analog-to-digital converters to respectively convert the analog data converted by the multiple light receiving elements to digital data in parallel form; circuitry configured to convert the digital data in parallel form converted by the multiple analog-to-digital converters to first image data in serial form in the main scanning direction and output the first image data having a first resolution; and an image processor to perform an image processing to second image data having a second resolution different from the first resolution.

### CROSS-REFERENCE TO RELATED APPLICATIONS

This patent application is based on and claims priority pursuant to 35 U.S.C. § 119 (a) to Japanese Patent Application No. 2024-080310, filed on May 16, 2024, in the Japan Patent Office, and Japanese Patent Application No. 2025-004075, filed on Jan. 10, 2025, in the Japan Patent Office the entire disclosure of which is hereby incorporated by reference herein.

### BACKGROUND

### Technical Field

The present embodiment relates to an image reading device, an image forming apparatus, and an image reading method.

### Related Art

In an image reading device, multiple light receiving elements, such as photodiodes, converts the respective charges accumulated due to light reception to voltages, and then the voltages are successively subjected to analog-to-digital (AD) conversion to generate multiple pieces of pixel data. Then, the generated multiple pieces of pixel data is successively output and then the pixel data is organized per line in a main scanning direction to read an image. Using AD conversion units and storage units provided one-to-one to the light receiving elements, part of one line is efficiently read.

### SUMMARY

The present disclosure described herein provides an image reading device includes a light receiving array including multiple light receiving elements arrayed in a main scanning direction, the multiple light receiving elements to perform photoelectrical conversion for corresponding pixels and output analog data, respectively; multiple analog-to-digital converters to respectively convert the analog data converted by the multiple light receiving elements to digital data in parallel form; circuitry configured to convert the digital data in parallel form converted by the multiple analog-to-digital converters to first image data in serial form in the main scanning direction and output the first image data having a first resolution; and an image processor to perform an image processing to second image data having a second resolution different from the first resolution. The circuitry is further configured to convert the first resolution of the first image data to the second resolution of the second image data and output the second image data to the image processor.

The present disclosure described herein further provides an image reading method includes: performing photoelectrical conversion for corresponding pixels and output analog data, respectively, by multiple light receiving elements arrayed in a main scanning direction; respectively converting the analog data to digital data in parallel form; converting the digital data in parallel form to first image data in serial form in the main scanning direction and outputting the first image data having a first resolution; performing an image processing to second image data having a second resolution different from the first resolution; and converting the first resolution of the first image data to the second resolution of the second image data and outputting the second image data for performing the image processing.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is a side view schematically illustrating an image reading device according to a first embodiment;

FIG. 2 is a block diagram illustrating an exemplary configuration of the image reading device according to the first embodiment;

FIG. 3 illustrates an exemplary functional configuration for data output processing and resolution conversion processing according to the first embodiment;

FIGS. 4A to 4C each illustrate the relationship between the position of an original document, a line synchronizing signal, image data, and the output section of a conversion output unit;

FIG. 5A illustrates an exemplary case where a light receiving element array is used in an optical system; FIG. 5B illustrates an exemplary case where a light receiving element array, which is different in pixel pitch from the light receiving element array in FIG. 5A, is used in the same optical system as in FIG. 5A;

FIG. 6 is a block diagram illustrating an exemplary configuration of an image reading device according to a second embodiment;

FIG. 7 is a block diagram illustrating an exemplary configuration of an image reading device according to a third embodiment;

FIG. 8 illustrates an exemplary functional configuration for data output processing and resolution conversion processing according to the third embodiment;

FIG. 9 is a block diagram illustrating an exemplary configuration of an image reading device according to a fourth embodiment;

FIG. 10 is a timing chart illustrating an exemplary operation of the image reading device;

FIG. 11 is a block diagram illustrating an exemplary configuration of an image reading device according to a fifth embodiment;

FIG. 12 illustrates an exemplary entire configuration of an image forming apparatus having the function of an image reading device; and

FIG. 13 illustrates an exemplary hardware configuration of the image forming apparatus having the function of the image reading device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of an image reading device, an image forming apparatus, and an image reading method will be described in detail below with reference to the accompanying drawings.

### First Embodiment

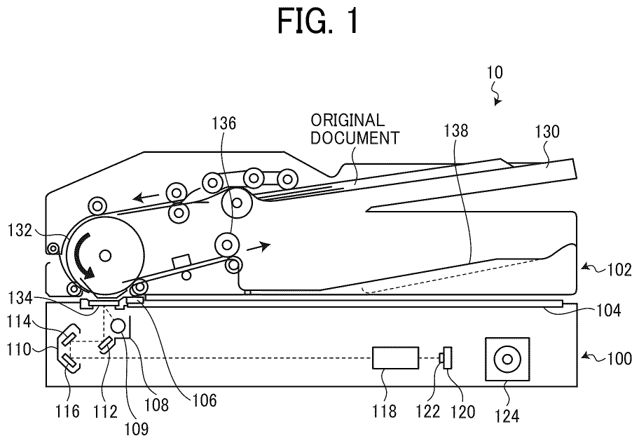

FIG. 1 is a side view schematically illustrating an image reading device 10 according to the present embodiment. For example, the image reading device 10 is of a sheet-through type and includes a reader body 100 (flatbed scanner) and an automatic document feeder (ADF) 102.

The reader body 100 includes a contact glass 104, a reference white board 106, a first carriage 108, a second carriage 110, a lens 118, a light receiving element array 122 provided to a light receiving element board 120, and a scanner motor 124. The first carriage 108 includes a light source 109 and a mirror 112. The second carriage 110 includes mirrors 114 and 116. The reader body 100 is provided with a reading window 134 through which an original document that the automatic document feeder 102 conveys is read. The light receiving element array 122 may be referred to simply as “light receiving array”.

The automatic document feeder 102 is disposed on the upper portion of the reader body 100 and automatically feeds and conveys an original document. The automatic document feeder 102 includes an original document tray 130, a conveying drum 132, a sheet ejection roller 136, and a sheet ejection tray 138. The automatic document feeder 102 conveys the original document placed on the original document tray 130 to the conveying drum 132, and then the conveying drum 132 conveys the original document to the reading window 134. While passing over the reading window 134, the original document is exposed by the light source 109. The reflection light from the original document is reflected by the mirror 112 of the first carriage 108 and the mirrors 114 and 116 of the second carriage 110, forming a reduced-size image on the light receiving face of the light receiving element array 122 on the light receiving element board 120 through the lens 118.

In flatbed reading, an original document is secured on the contact glass 104, and the original document is then read by the first carriage 108 and the second carriage 110 scanning and moving in a sub-scanning direction of the original document. The original document on the contact glass 104 is irradiated with light from the light source 109 below the contact glass 104. The reflection light from the original document is reflected by the mirror 112 of the first carriage 108 and the mirrors 114 and 116 of the second carriage 110, forming a reduced-size image on the light receiving face of the light receiving element array 122 on the light receiving element board 120 through the lens 118. In this case, the image reading device 10 reads the entire original document with the first carriage 108 moving at a rate V in the sub-scanning direction of the original document and the second carriage 110 moving at a rate 1/2V, which is half the rate V of the first carriage 108, in conjunction with the first carriage 108.

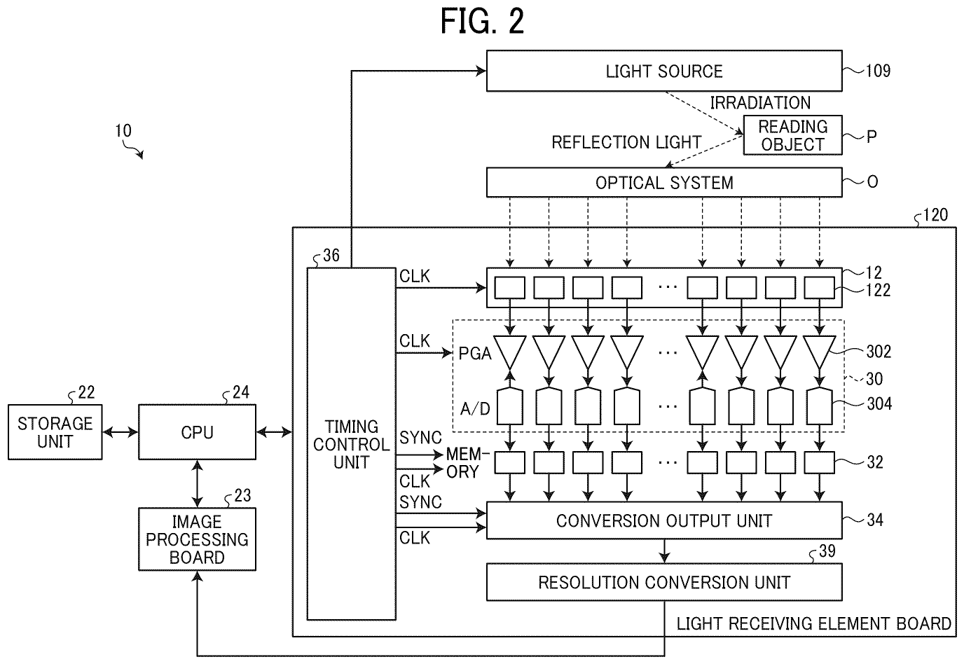

Next, an exemplary configuration of the image reading device 10 according to the present embodiment will be described in detail. FIG. 2 is a block diagram illustrating an exemplary configuration of the image reading device 10 according to the present embodiment. The image reading device 10 includes the light source 109, the light receiving element board 120, a storage unit 22, an image processing board 23, and a central processing unit (CPU) 24.

The light source 109 is, for example, a light emitting diode (LED) array and irradiates a reading object P, such as an original document, with light. The reflection light from the reading object P forms an image on the light receiving element array 122 on the light receiving element board 120 due to an optical system O including the mirrors 112, 114, and 116 and the lens 118 described above. The light receiving element board 120 photoelectrically converts the reflection light having formed the image and performs conversion to image data to output the image data. The storage unit 22 includes a hard disk drive (HDD) or a memory. The image processing board 23 performs various types of image processing to the output image data. The CPU 24 controls the constituents in the image reading device 10. The image processing board 23 is an example of an image processor.

Next, the light receiving element board 120 will be described in detail. The light receiving element board 120 is, for example, a complementary metal oxide semiconductor (CMOS) linear image sensor and includes the light receiving element array 122, an analog processing unit 30, memories 32, a conversion output unit 34, a timing control unit 36, and a resolution conversion unit 39.

For example, the light receiving element array 122 includes 7000 light receiving elements (photodiodes) 12 that receive light and correspond one-to-one to 7000 pixels arrayed in a direction. The timing control unit 36 generates a clock (CLK) and a line synchronizing signal (SYNC) necessary for the operation of each constituent in the light receiving element board 120.

The analog processing unit 30 includes amplifiers such as programmable gain amplifiers (PGAs)) 302 corresponding one-to-one to the light receiving elements 12 and AD conversion units 304 corresponding one-to-one to the light receiving elements 12.

The light receiving elements 12 each accumulate incident light as charge and a charge detector converts the charge to voltage. The amplifiers 302 each amplify the corresponding voltage resulting from the conversion (analog signal) and then output the amplified voltage to the corresponding AD conversion unit 304. The AD conversion units 304 each convert the analog signal as pixel data received from the corresponding amplifier 302 to a digital signal in parallel with the other AD conversion units 304 and output the digital signal resulting from the conversion (digital data) to the corresponding memory 32.

For example, when the number of pixels is 7000, the light receiving element board 120 includes 7000 light receiving elements 12, 7000 amplifiers 302, 7000 AD conversion units 304, and 7000 memories 32.

The memories 32 each serve as a storage unit that corresponds to a pixel and stores the digital data converted by the corresponding AD conversion unit 304. The conversion output unit 34 reads the digital data stored in the memories 32 and then converts the read digital data to image data as serial data in the main scanning direction. Then, the conversion output unit 34 outputs the image data. That is, the conversion output unit 34 performs parallel-serial conversion to generate image data.

The resolution conversion unit 39 converts the resolution of the image data output by the conversion output unit 34. The resolution of the image data is, for example, the number of pixels (number of dots) per unit length. In a case where the resolution of the image data output by the conversion output unit 34 is 700 dots per inch (dpi) and the image processing board 23 needs image data having a resolution of 600 dpi for image processing, the resolution conversion unit 39 converts image data having an input resolution of 700 dpi to image data having an output resolution of 600 dpi. For such resolution conversion, a well-known algorithm, such as pixel reduction or interpolation, can be used together with a low-pass filter. Note that, in a case where the light receiving element board 120 is equipped with the resolution conversion unit 39, the image data can be output at a target resolution from the light receiving element board 120. Thus, as an advantage, the following image processing is unaffected by replacement of a light receiving element array.

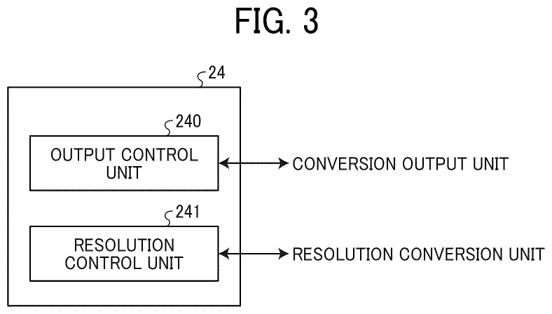

FIG. 3 illustrates an exemplary functional configuration for data output processing and resolution conversion processing according to the present embodiment. As illustrated in FIG. 3, the CPU 24 in the image reading device 10 includes an output control unit 240 and a resolution control unit 241.

Using an output start pixel and an output end pixel for the conversion output unit 34 to output image data in the main scanning direction, the output control unit 240 controls the conversion output unit 34 to output the image data ranging from the output start pixel to the output end pixel. For example, the output start pixel and the output end pixel each correspond to a predetermined coordinate value read from the storage unit 22 or a register. For example, coordinate values of 0 to 6999 are allocated one-to-one to the 7000 pixels arrayed in the main scanning direction. In a case where the coordinate value of the output start pixel is 10 and the coordinate value of the output end pixel is 4999, the conversion output unit 34 outputs the image data corresponding to coordinate values of 10 to 4999. Note that, in the present embodiment, the output control unit 240 may be omitted. In this case, the conversion output unit 34 reads a predetermined output start pixel and a predetermined output end pixel from a register or the like and then reads digital data from the corresponding memories 32 in accordance with the coordinate values thereof.

The output control unit 240 may control the output start pixel and the output end pixel to have their coordinate values changed. For example, the output control unit 240 changes the respective coordinate values of the output start pixel and the output end pixel in accordance with the image processing that the image processing board 23 performs. In this case, the output control unit 240 transmits the respective changed coordinate values of the output start pixel and the output end pixel to the conversion output unit 34 to control the conversion output unit 34 to read the digital data ranging from the output start pixel to the output end pixel after the change.

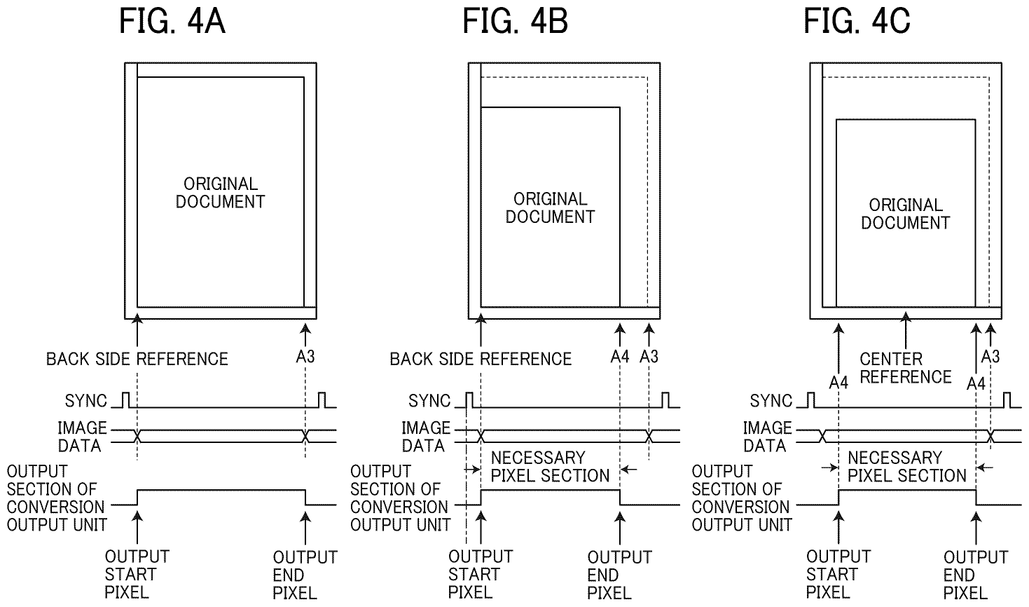

FIGS. 4A to 4C each illustrate the relationship between the position of an original document, the line synchronizing signal, the image data, and the output section of the conversion output unit 34. FIGS. 4A to 4C each illustrate, on its upper side, the position of the original document placed on the contact glass 104 and each illustrate, on its lower side, the line synchronizing signal, the image data to be read, and the timings of the output start pixel and the output end pixel.

FIG. 4A illustrates an example in which the image reading device 10 enabling maximum A3-sized reading reads an A3-sized original document placed. The image data to be output by the conversion output unit 34 has a width corresponding to an A3 short side size. For reading at 600 dpi, the coordinate value of the output start pixel is set to 0 and the coordinate value of the output end pixel is set to 7020. Then, the image data, of which the width corresponds to an A3 short side size, is output.

FIGS. 4B and 4C each illustrate an example in which the image reading device 10 enabling maximum A3-sized reading reads an A4-sized original document placed. In a case where the width of the original document is smaller than a readable maximum width, a line of image data includes an unnecessary pixel section. For example, regarding a type in which an original document is set with a back side reference to the image reading device 10 (refer to FIG. 4B), the necessary pixel section and unnecessary pixel section of a line of image data are located on the left side and right side, respectively. Regarding another type in which an original document is set with a center reference to the image reading device 10 (refer to FIG. 4C), part on the left side and part on the right side of the pixel section of a line of image data are unnecessary.

In the present embodiment, the conversion output unit 34 outputs the image data in the necessary pixel section using the respective coordinate values of the output start pixel and the output end pixel. For example, for reading an A4-sized original document with the back side reference, the output control unit 240 sets the respective coordinate values of the output start pixel and the output end pixel to 0 and 4960, respectively. Then, the conversion output unit 34 outputs the image data in the necessary pixel section.

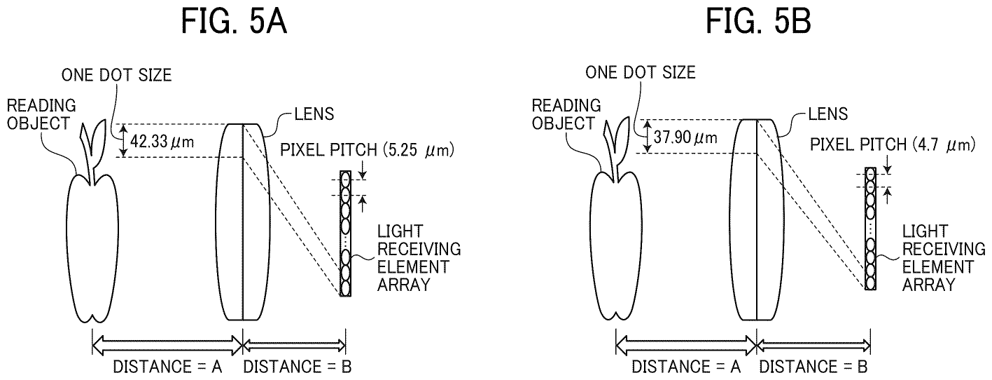

The resolution control unit 241 controls the resolution conversion unit 39 to convert the resolution of the image data to a resolution corresponding to the light receiving element array 122. FIG. 5A illustrates an exemplary case where a light receiving element array is used in an optical system. FIG. 5B illustrates an exemplary case where a light receiving element array, which is different in pixel pitch from the light receiving element array in FIG. 5A, is used in the same optical system as in FIG. 5A. Referring to FIGS. 5A and 5B, the distance from a reading object to a lens is A, and the distance from the lens to the light receiving element array is B. The pixel pitch of the light receiving element array in FIG. 5A is 5.25 μm and the pixel pitch of the light receiving element array in FIG. 5B is 4.7 μm.

Referring to FIG. 5A, in a case where the optical system is designed for a resolution of 600 dpi, the size of one dot (pixel) is approximately 42.33 μm (25.4 mm/600). For image forming onto the light receiving element array having a pixel pitch of 5.25 μm, the optical system is designed to reduce the image size of the reading object to approximately 1/8.06 and form the reduced-size image at a target position. As in FIG. 5B, in a case where the light receiving element array having a pixel pitch of 4.7 μm is used in the same optical system as in FIG. 5A, the size of one dot is approximately 37.90 μm (=4.7 μm×approximately 8.06), leading to a resolution of approximately 670 dpi.

In such an example, in a case where a resolution of 600 dpi is necessary for image processing, the resolution control unit 241 controls the resolution conversion unit 39 to convert the resolution of the image data from 670 dpi to 600 dpi. Specifically, an input resolution of 670 dpi and an output resolution of 600 dpi are set, and the resolution conversion unit 39 controls the resolution of the image data output from the conversion output unit 34 to be converted from the input resolution to the output resolution.

In general, after a light receiving element array having a pixel pitch of X μm is replaced with a light receiving element array having a pixel pitch of Y μm, for adjustment of the resolution after the replacement to the resolution before the replacement, an input resolution of (1000×25.4×α/Y) dpi and an output resolution of (1000×25.4×α/X) dpi are set. Note that a represents the reduction rate of the optical system (in the above-described example, approximately 1/8.06). The resolution control unit 241 sets the input resolution and the output resolution depending on the light receiving element array and then controls the resolution conversion unit 39 to convert the resolution of the image data based on the input resolution and the output resolution. Note that parameters for the resolution control unit 241 to control the resolution conversion unit 39 are not limited to the input resolution and the output resolution. For example, a parameter, such as the rate of conversion for resolution conversion (reduction rate or magnification rate), may be provided. The rate of conversion can be calculated by the following expression: output resolution/input resolution.

As above, according to the present embodiment, in a case where the light receiving element array is replaced with another light receiving element array, resolution conversion can be performed to obtain the resolution before the replacement. Thus, light receiving element arrays different in pixel pitch can be each used in the image reading device without redesigning the optical system. Furthermore, a light receiving element array having a certain pixel pitch can be used easily as a component common to multiple image reading devices different in the design of an optical system, leading to a reduction in the number of steps for development and a reduction in manufacturing cost.

### Second Embodiment

According to a second embodiment, a resolution conversion unit 39 is provided outside a light receiving element board 120. Differences between the second embodiment and the first embodiment will be described below, but description of the overlaps between the second embodiment and the first embodiment will be omitted.

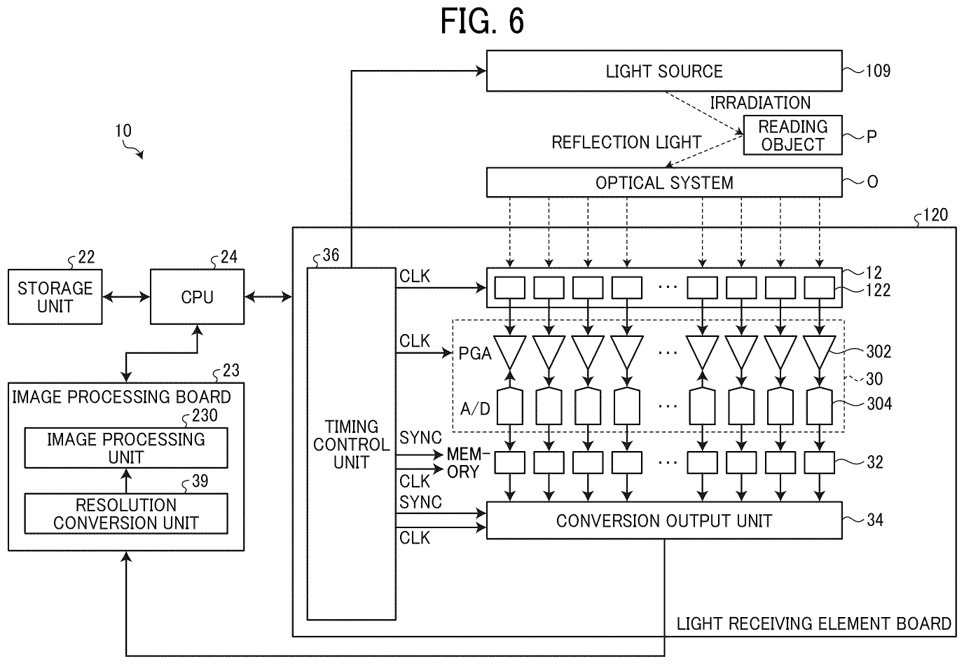

FIG. 6 is a block diagram illustrating an exemplary configuration of an image reading device 10 according to the present embodiment. Differently from the first embodiment, the resolution conversion unit 39 is provided to an image processing board 23, instead of to the light receiving element board 120. In general, the image processing board 23 is larger in the scale for circuitry than the light receiving element board 120 and thus has a sufficient scale for circuitry as a design. Thus, the resolution conversion unit 39 can be mounted on the image processing board 23 with no increase in the scale for circuitry of the image processing board 23.

The image processing board 23 includes the resolution conversion unit 39 and an image processing unit 230. Similarly to the first embodiment, the resolution conversion unit 39 coverts the resolution of image data under control of a resolution control unit 241. The image processing unit 230 performs various types of image processing to the image data output from the resolution conversion unit 39.

As above, according to the present embodiment, since the resolution conversion unit is provided outside the light receiving element board, a reduction can be made in the scale for circuitry of the light receiving element board. Since the resolution conversion unit can be mounted on the image processing board with no increase in the scale for circuitry of the image processing board, a reduction can be made in the scale for circuitry of the entire image reading device, leading to a reduction in cost. Similarly to the first embodiment, in a case where the light receiving element array is replaced with another light receiving element array, resolution conversion can be performed to obtain the resolution before the replacement. Thus, light receiving element arrays different in pixel pitch can be each used in the image reading device without redesigning an optical system.

### Third Embodiment

According to a third embodiment, parameters for a resolution conversion unit 39 to perform resolution conversion (input resolution and output resolution) can be set freely from outside. Differences between the third embodiment and the first embodiment will be described below, but description of the overlaps between the third embodiment and the first embodiment will be omitted.

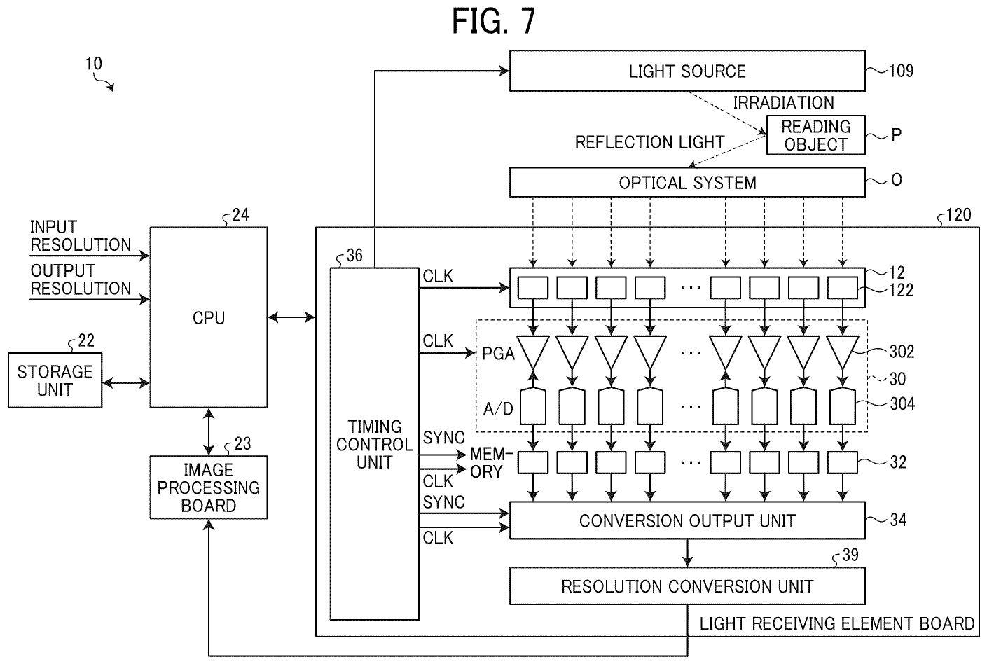

FIG. 7 is a block diagram illustrating an exemplary configuration of an image reading device 10 according to the present embodiment. Differently from the first embodiment, the input resolution and the output resolution can be input to a CPU 24.

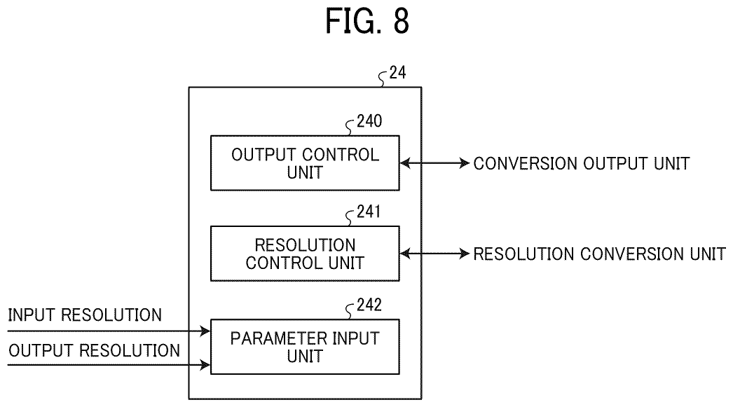

FIG. 8 illustrates an exemplary functional configuration for data output processing and resolution conversion processing according to the present embodiment. Differently from the first embodiment, the CPU 24 includes a parameter input unit 242 as an addition. The parameter input unit 242 receives the input resolution input to the parameter input unit 242 and output resolution and then transmits the input resolution and the output resolution to a resolution control unit 241. In response to reception of the input resolution and the output resolution from the parameter input unit 242, using the received input resolution and output resolution, the resolution control unit 241 controls a resolution conversion unit 39 to perform resolution conversion. Thus, the input resolution and the output resolution for resolution conversion can be set freely from outside.

For example, for the input resolution and the output resolution, a storage unit 22 stores multiple sets of fixed values in a register in advance. Depending on the light receiving element array, a set of values read from the storage unit 22 is input to the parameter input unit 242. Through an operation panel or the like, an engineer or a user may input parameters, such as the input resolution and the output resolution, for resolution conversion.

Note that, referring to FIG. 7, the resolution conversion unit 39 is provided to a light receiving element board 120 but may be provided to an image processing board 23, similarly to the second embodiment. For example, as input data to the parameter input unit 242, the rate of conversion for resolution conversion may be provided.

As above, according to the present embodiment, since the parameters for resolution conversion can be set freely from outside, in a case where the light receiving element array is replaced with another light receiving element array, the parameters for resolution conversion can be set easily to obtain the resolution before the replacement.

### Fourth Embodiment

According to a fourth embodiment, the period of a line synchronizing signal is changed based on an output start pixel and an output end pixel, and the reading line speed of an image reading device 10 is changed in accordance with the changed period. Differences between the fourth embodiment and the third embodiment will be described below, but description of the overlaps between the fourth embodiment and the third embodiment will be omitted.

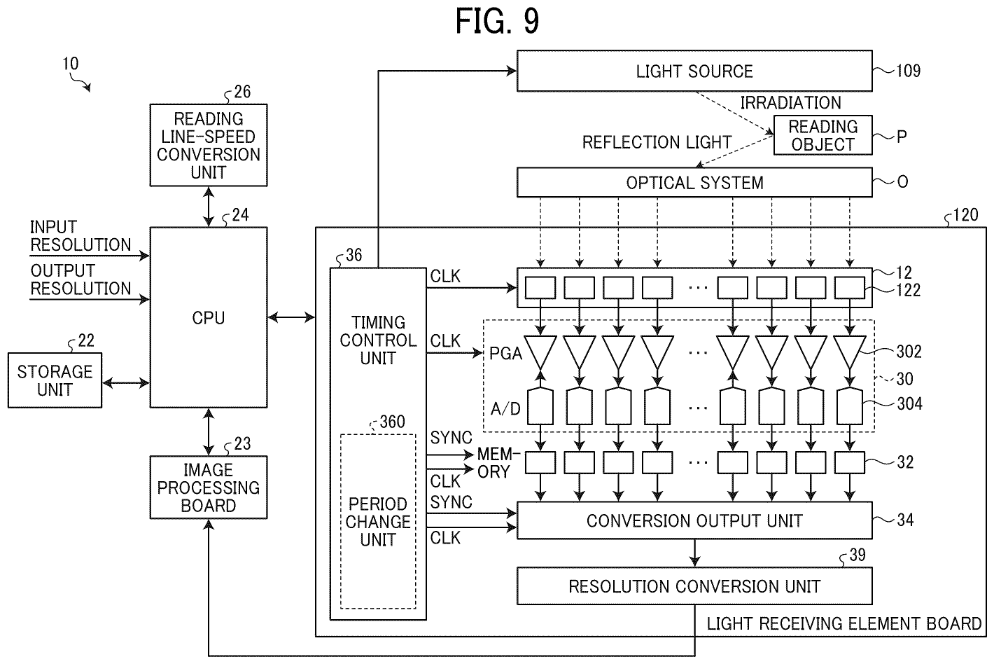

FIG. 9 is a block diagram illustrating an exemplary configuration of the image reading device 10 according to the present embodiment. Differently from the third embodiment, a timing control unit 36 includes a period change unit 360, and a reading line-speed change unit 26 is provided.

The period change unit 360 changes the period of the line synchronizing signal (SYNC) (line section), based on the output start pixel and the output end pixel controlled by an output control unit 240. Then, the period change unit 360 changes, for example, the period in which each light receiving element 12 performs photoelectric conversion, the period in which each AD conversion unit 304 performs AD conversion, the period in which each memory 32 stores digital data, and the period in which a conversion output unit 34 converts the digital data to serial data in a main scanning direction.

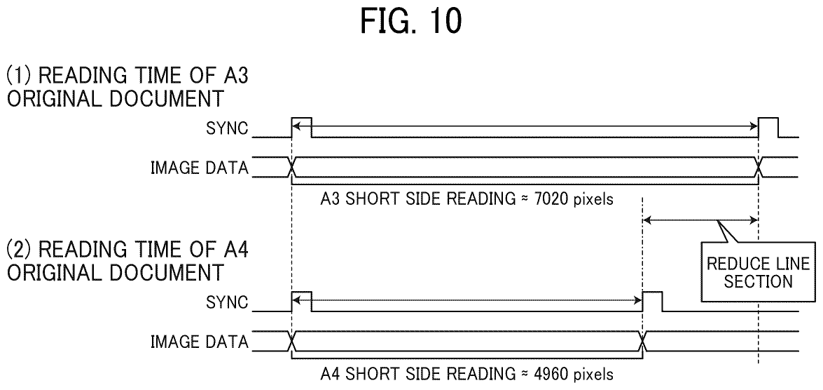

FIG. 10 is a timing chart illustrating an exemplary operation of the image reading device 10. In this example, a light receiving element board 120 corresponds to, for example, an original document having an A3 short side size (297 mm: approximately 7020 pixels) and has a number of reading pixels corresponding to 600 dpi. For reading an original document having an A4 short side size (210 mm: approximately 4960 pixels) with a back side reference, the output control unit 240 causes the output end pixel to have a coordinate value that is 1/(the positive square root of 2) of the coordinate value at the reading time of an A3 short side. Then, the light receiving element board 120 outputs image data for approximately 4960 pixels. In the present embodiment, the line synchronizing signal is changed in accordance with the number of pixels of image data to be output, and the conversion output unit 34 reads digital data for a size that is 210/297 of an A3 short side size from the corresponding memories 32. Then, the conversion output unit 34 converts the read digital data to image data and then outputs the image data. Thus, the conversion output unit 34 performs no reading for unnecessary pixels. Hereinafter, the positive square root of 2 is referred to as sqrt2.

As above, the light receiving element board 120 shortens the line section in accordance with a reduction in the number of pixels for output. Thus, for an original document having an A4 short side size, the reading time for one line in the main scanning direction can be reduced to 1/sqrt2 (=210/297).

That is, the image reading device 10 changes the number of pixels for output in accordance with the size of the original document to be read, so that the line section can be shortened in accordance with the number of pixels for output without reading for unnecessary pixels. Note that, in practice, the image reading device 10 needs reading for optical black (OPB) pixels and invalid pixels, in addition to the effective pixels. In the present embodiment, for simplification, the effective pixels are described.

In the example in FIG. 10, the original document is arranged with the back side reference in flatbed reading or sheet-through reading. For example, in a case where the original document is arranged with a center reference, the output control unit 240 changes the output start pixel and the output end pixel for the original document in accordance with the size of the original document.

Furthermore, according to the image reading device 10, the main scanning direction may invert between at the time of flatbed reading and at the time of sheet-through reading because flatbed reading and sheet-through reading are different in the orientation of the original document and in the type of scanning. In this case, when the size in the main scanning direction of the original document is smaller than the size of an original document readable maximum by the image reading device 10, an inversion is made in the positions of pixels unnecessary for reading. For example, in a case where the 5000th to 7000th pixels are unnecessary to the light receiving element board 120 at the time of flatbed reading, the 0th to 2000th pixels are unnecessary at the time of sheet-through reading. In the image reading device 10, based on the setting made in advance or a result of photoelectric conversion of each light receiving element 12, the output control unit 240 changes the output start pixel and the output end pixel for serial data in the main scanning direction and then the line section is changed, so that an image can be read depending on the reading type without reading for unnecessary pixels.

In accordance with the line section changed by the period change unit 360, the reading line-speed change unit 26 changes the reading line speed at which each light receiving element 12 photoelectrically converts respective beams of reflection light from positions different in a sub-scanning direction, successively. Specifically, the reading line-speed change unit 26 changes the conveyance rate of the original document at the time of sheet-through reading and changes the scanning rates of a first carriage 108 and a second carriage 110 (hereinafter, collectively referred to as a “carriage”) at the time of flatbed reading.

In the image reading device 10, for example, in a case where the light receiving element board 120 can read an original document having an A3 short side size in the main scanning direction like the operation illustrated in FIG. 10, the number of necessary pixels is reduced to 1/sqrt2 and the line section is reduced to 1/sqrt2 at the reading time of an original document having an A4 short side size. That is, multiplying the conveyance rate of the original document by sqrt2 at the time of sheet-through reading or multiplying the scanning rate of the carriage by sqrt2 at the time of flatbed reading causes the image reading device 10 to have an optimum relationship between the line section and the reading line speed. Therefore, at the reading time of an A4 original document, the image reading device 10 can read the original document at a rate that is sqrt2 times the rate at which pixel data for an A3 original document is read, leading to an improvement in productivity.

In the image reading device 10, based on the setting made in advance or a result of photoelectric conversion of each light receiving element 12, the output control unit 240 controls the output start pixel and the output end pixel to be changed for serial data in the main scanning direction. For example, in the image reading device 10, multiple setting values for the output start pixel and the output end pixel may be stored in advance in a storage unit 22 or a register and setting values may be selected depending to the set reading type. That is, the storage unit 22 or the register serves as a setting storage unit that stores in advance two or more settings regarding the output start pixel and the output end pixel for serial data in the main scanning direction and two or more settings for the period change unit 360 to change the line section.

Note that, referring to FIG. 9, parameters for resolution conversion are input from outside, but a resolution control unit 241 may set such parameters, similarly to the first embodiment. Referring to FIG. 9, a resolution conversion unit 39 is provided to the light receiving element board 120. The resolution conversion unit 39 may be provided to an image processing board 23, similarly to the second embodiment.

As above, according to the present embodiment, the line section is changed in accordance with the size of the original document to be read in practice, enabling an improvement in reading rate. Similarly to the first embodiment, in a case where the light receiving element array is replaced with another light receiving element array, resolution conversion can be performed to obtain the resolution before the replacement. Thus, light receiving element arrays different in pixel pitch can be each used in the image reading device without redesigning an optical system.

### Fifth Embodiment

According to a fifth embodiment, the amount of light of a light source 109 can be adjusted in accordance with a line section. Differences between the fifth embodiment and the fourth embodiment will be described below, but description of the overlaps between the fifth embodiment and the fourth embodiment will be omitted.

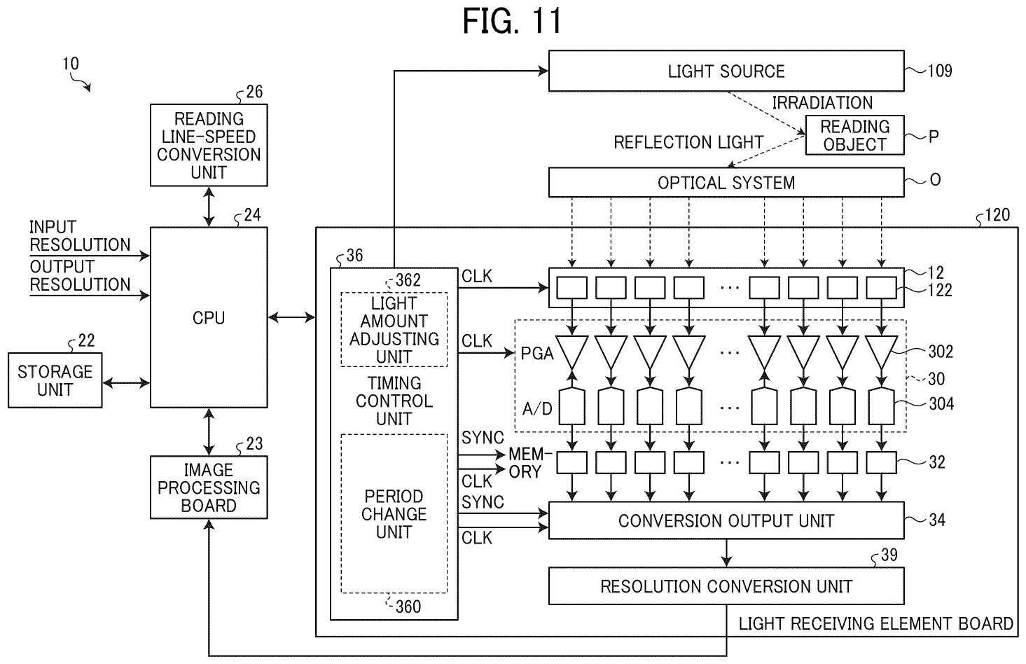

FIG. 11 is a block diagram illustrating an exemplary configuration of an image reading device 10 according to the present embodiment. Differently from the fourth embodiment, a timing control unit 36 includes a light amount adjusting unit 362. Like the fourth embodiment, in a case where a period change unit 360 changes the line section and then reading is performed with an amount of light identical to the amount of light before the changing, the amount of charge to be accumulated to a light receiving element array 122 varies. A reduction in line section and an increase in reading line speed cause a disadvantage, such as a reduction in the time of accumulation to the light receiving element array 122 or a deterioration in the signal-to-noise ratio (S/N) of read data. An increase in line section (a decrease in reading line speed) may cause the light receiving element array 122 to have a saturated output, leading to a disadvantage such as a deterioration in the quality of reading of a bright original document. In the present embodiment, the amount of light is adjusted in accordance with the changed line section to solve such disadvantages as above.

The light amount adjusting unit 362 changes the duty cycle of a driving signal for turning on the light source 109 or the amount of current of the driving signal. Regarding a change in duty cycle, in accordance with the line section changed by the period change unit 360, the light amount adjusting unit 362 changes the duty cycle of the driving signal for turning on the light source 109 to adjust the amount of light of the light source 109. The duty cycle is defined as the ratio between the active period and negative period of the driving signal for the light source 109. Specifically, in a case where the duty cycle has the ratio 50%:50% at the reading time of an A3 original document, when the period change unit 360 changes the line section to 1/sqrt2 at the reading time of an A4 original document, the light amount adjusting unit 362 causes the duty cycle to have the ratio 70%:30%. Thus, the amount of charge to be accumulated to the light receiving element array 122 during the processing period of one line in a main scanning direction can be prevented from being reduced, so that the quality (S/N) of image data can be retained.

Regarding a change in the amount of current, the light amount adjusting unit 362 changes the amount of current of the driving signal for turning on the light source 109 to adjust the amount of light of the light source 109. That is, even in a case where a change in the duty cycle of the driving signal for turning on the light source 109 is insufficient to adjust the amount of light, the image reading device 10 enables prevention of a reduction in the amount of light of the light source 109.

As above, according to the present embodiment, the amount of light of the light source is adjusted in accordance with the line section. Thus, even in a case where the line section is changed, the quality of reading can be prevented from being deteriorated. Similarly to the first embodiment, in a case where the light receiving element array is replaced with another light receiving element array, resolution conversion can be performed to obtain the resolution before the replacement. Thus, light receiving element arrays different in pixel pitch can be each used in the image reading device without redesigning an optical system.

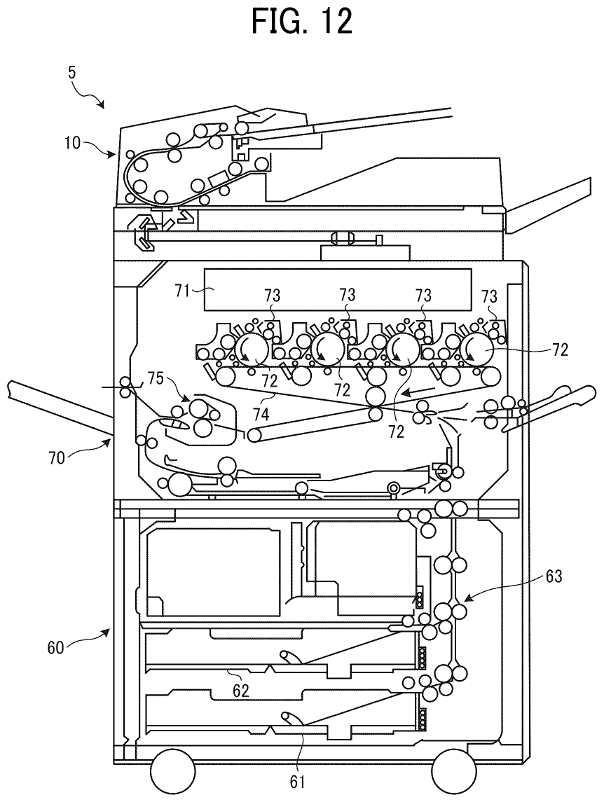

Next, an image forming apparatus 5 including an image reading device 10 will be described. FIG. 12 illustrates an exemplary entire configuration of the image forming apparatus 5 having the function of the image reading device 10.

As illustrated in FIG. 12, the image forming apparatus 5 includes the image reading device 10, a sheet feeder 60, and an image former 70. The sheet feeder 60 includes sheet feeding cassettes 61 and 62 that each store recording sheets. The recording sheets stored in the sheet feeding cassette 61 and the recording sheets stored in the sheet feeding cassette 62 are different in sheet size. The sheet feeder 60 includes a sheet feeding mechanism 63 including various types of rollers that convey, to an image forming position in the image former 70, the recording sheets stored in the sheet feeding cassettes 61 and 62.

The image former 70 includes an exposure device 71, photoconductor drums 72, developing devices 73, a transfer belt 74, and a fixing device 75. In the image former 70, based on image data of the original document read by the image reading device 10, the exposure device 71 exposes the photoconductor drums 72 to form a latent image on each photoconductor drum 72. In the image former 70, the developing devices 73 each supply toner to the corresponding photoconductor drum 72 and perform development. The respective toners to the photoconductor drums 72 are different in color. Then, in the image former 70, the transfer belt 74 transfers the respective images developed on the photoconductor drums 72 to the recording sheet supplied from the sheet feeder 60. Then, the fixing device 75 fuses the toner of each toner image transferred to the recording sheet to fix a color image to the recording sheet.

Note that, although the image former 70 forms an image in such an electrophotographic manner as described above, the image former 70 may form an image in an inkjet manner. The image forming apparatus 5 is not limited to a multifunction peripheral (MFP) having at least two functions of a copy function, a printer function, a scanner function, or a facsimile function, and thus may be any image forming apparatus, such as a copier, a scanner, or a facsimile. For example, the image forming apparatus 5 may be a printer that receives, by communication, the image data generated by the image reading device 10, which is separate therefrom, to print out the received image data.

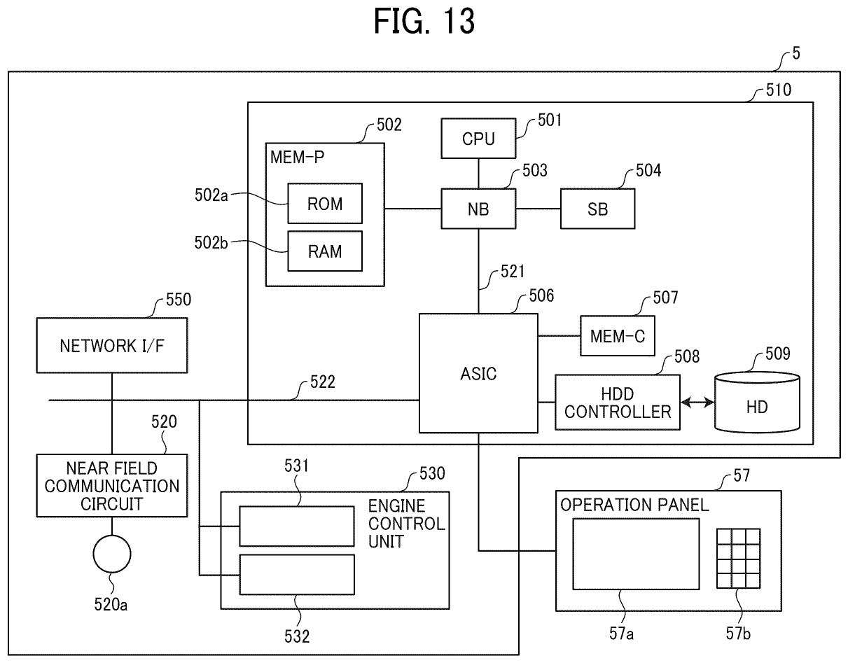

FIG. 13 illustrates an exemplary hardware configuration of the image forming apparatus 5 having the function of the image reading device 10. For example, the image forming apparatus 5 serves as a copier or a multifunction peripheral (MFP) that includes a scan processing unit 531 that performs the function of the image reading device 10 and a print processing unit 532 that performs image formation.

The image forming apparatus 5 includes a controller 510, a near field communication circuit 520, an engine control unit 530, an operation panel 57, and a network interface (I/F) 550.

The controller 510 includes a central processing unit (CPU) 501 as a main part of a computer, a system memory (MEM-P) 502, a northbridge (NB) 503, a southbridge (SB) 504, an application specific integrated circuit (ASIC) 506, a local memory (MEM-C) 507 as a storage unit, a hard disk drive (HDD) controller 508, and a hard disk (HD) 509 as a storage unit. Note that a solid state drive (SSD) may be used as a storage unit. Note that the CPU 501 may be a processor integrated with a CPU 24, and the HD 509 may be a device integrated with a storage unit 22.

The NB 503 and the ASIC 506 are connected through an accelerated graphics port (AGP) bus 521.

The CPU 501 serves as a control unit that controls the entire image forming apparatus 5. The NB 503 serves as a bridge for connecting the CPU 501, the MEM-P 502, the SB 504, and the AGP bus 521, and includes a memory controller that controls writing to the MEM-P 502, a peripheral component interconnect (PCI) master, and an AGP target.

The MEM-P 502 includes a read only memory (ROM) 502a serving as a memory for storing a program and data that implement each function of the controller 510, and a random access memory (RAM) 502b to be used for expanding such a program or data or as a drawing memory at the time of memory printing. Note that the program stored in the RAM 502b may be recorded, in an installable file format or in an executable file format, on a computer-readable recording medium, such as a compact disc read only memory (CD-ROM), a compact disc recordable (CD-R), or a digital versatile disc (DVD), for provision.

The SB 504 serves as a bridge for connecting the NB 503 to a PCI device or a peripheral device. The ASIC 506 serves as an integrated circuit (IC) for image processing having a hardware element for image processing, and functions as a bridge that connects the AGP bus 521, a PCI bus 522, the HDD controller 508, and the MEM-C 507.

The ASIC 506 includes a PCI target, an AGP master, an arbiter (ARB) that forms the core of the ASIC 506, a memory controller that controls the MEM-C 507, multiple direct memory access controllers (DMAC) that rotates image data by hardware logic or the like, and a PCI unit that performs data transfer between the scan processing unit 531 and the print processing unit 532 through the PCI bus 522. Note that, for connection to the ASIC 506, an interface based on universal serial bus (USB) or an interface based on Institute of Electrical and Electronics Engineers 1394 (IEEE 1394) may be used.

The MEM-C 507 corresponds to a local memory to be used as a copy image buffer or a code buffer. The HD 509 corresponds to a storage for accumulating image data, accumulating font data to be used at the time of printing, and accumulating forms. The HD 509 controls reading of data from the HD 509 or writing of data to the HD 509 under the control of the CPU 501.

The AGP bus 521 serves as a bus interface for a graphics accelerator card designed for speeding up graphics processing. The AGP bus 521 enables direct access to the MEM-P 502 at a high throughput to speed up the graphics accelerator card.

The near field communication circuit 520 includes a near field communication antenna 520a. The near field communication circuit 520 serves as a communication circuit for near field communication (NFC) or Bluetooth®.

Furthermore, the engine control unit 530 includes the scan processing unit 531 and the print processing unit 532. The operation panel 57 includes a panel display 57a such as a touch panel that displays the current setting values or selection screens and receives an input from an operator and an operation key 57b including a numeric keypad that receives a setting value for a condition related to image formation, such as a setting value for a density condition, and a start key that receives an instruction for starting copying. Note that the panel display 57a can receive a touch input from a user and thus the user can operate, with its finger or a pen, to input a numerical value to an input box, make a selection from a pull-down menu, or make a switch between ON and OFF to a check box, displayed on the screen. The operation key 57b may include an input device, such as a trackball or a touchpad, in addition to the numeric keypad.

The controller 510 controls the entire image forming apparatus 5. For example, the controller 510 controls drawing, communication, or an input from the operation panel 57. The scan processing unit 531 performs image reading using the image reading device 10 described in any of the first to fifth embodiments to generate image data. The print processing unit 532 includes a transferer that transfers an image of color material, such as a toner image, to a conveyance medium such as a sheet, a fixer that fixes the image, and a heater or a dryer, and performs image formation to the sheet. Furthermore, the scan processing unit 531 or the print processing unit 532 performs image processing, such as error diffusion or gamma correction.

Note that such a sheet is an exemplary conveyance medium. A conveyance medium is not necessarily a paper sheet and may be any medium, such as a film or a plastic sheet, which can be stored in a sheet feeding cassette included in the image forming apparatus 5 and can be conveyed and output in response to an instruction for outputting a sheet.

The network I/F 550 serves as an interface for data communication using a communication network. The near field communication circuit 520 and the network I/F 550 are electrically connected to the ASIC 506 through the PCI bus 522.

Note that the image forming apparatus 5 illustrated in FIG. 13 may have either an electrophotographic image forming mechanism or a different image forming mechanism, such as an inkjet image forming mechanism.

Some embodiments of the present embodiment have been described above, and the embodiments described above are just exemplary and are not intended to limit the scope of the present embodiment. Such novel embodiments can be carried out in other various modes and thus various omissions, replacements, and alterations can be made without departing from the gist of the present embodiment. The novel embodiments and modifications thereof are included in the scope and gist of the present embodiment and additionally are included in the scope of the present embodiment in the claims and the equivalents thereof. Furthermore, some constituent elements in different embodiments and modifications may be combined as appropriate.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

Each function in each embodiment described above can be implemented by a single processing circuit or multiple processing circuits. The term “processing circuit” herein includes a processor programmed to perform each function by software, such as a processor implemented by an electronic circuit, and devices, such as an ASIC, a digital signal processor (DSP), a field programmable gate array (FPGA), and conventional circuit modules, which are designed to perform the above-described functions.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

An image reading device includes a light receiving array including multiple light receiving elements arrayed in a main scanning direction, the multiple light receiving elements to perform photoelectrical conversion for corresponding pixels and output analog data, respectively; multiple analog-to-digital converters to respectively convert the analog data converted by the multiple light receiving elements to digital data in parallel form; circuitry configured to convert the digital data in parallel form converted by the multiple analog-to-digital converters to first image data in serial form in the main scanning direction and output the first image data having a first resolution; and an image processor to perform an image processing to second image data having a second resolution different from the first resolution. The circuitry is further configured to convert the first resolution of the first image data to the second resolution of the second image data and output the second image data to the image processor.

The circuitry is further configured to: change an output start pixel and an output end pixel of the first image data in the serial form in the main scanning direction according to the image processing performed by the image processor; and read the digital data in the parallel form based on the output start pixel and the output end pixel changed according to the image processing. The image reading device further includes a light receiving element board including: the light receiving array; the multiple analog-to-digital converters; and the circuitry, on the light receiving element board.

The image reading device further includes an image processing board including: the image processor; and the circuitry configured to convert the first resolution of the first image data to the second resolution of the second image data and output the second image data to the image processor. The circuitry is further configured to: set a resolution conversion parameter to convert the first resolution to the second resolution; and convert the first resolution of the first image data to the second resolution of the second image data, based on the resolution conversion parameter.

The circuitry is further configured to: convert the digital data in the parallel form to the first image data in the serial form in the main scanning direction at a first period; change the first period to a second period different from the first period based on the output start pixel and the output end pixel; and control each of the multiple light receiving elements to photoelectrically convert respective beams of light from different positions in a sub-scanning direction orthogonal to the main scanning direction at a first reading line speed; and change the first reading line speed to a second reading line speed different from the first reading line speed according to a change from the first period to the second period.

The image reading device further includes: a light source to irradiate an original document with a first light amount; and the circuitry further configured to control the light source to change the first light amount to a second light amount different from, the first light amount according to the change from the first period to the second period. An image forming apparatus includes the image reading device to read image on an original document; and an image former to form an image on a medium based on the image read by the image reading device.

An image reading method includes: performing photoelectrical conversion for corresponding pixels and output analog data, respectively, by multiple light receiving elements arrayed in a main scanning direction; respectively converting the analog data to digital data in parallel form; converting the digital data in parallel form to first image data in serial form in the main scanning direction and outputting the first image data having a first resolution; performing an image processing to second image data having a second resolution different from the first resolution; and converting the first resolution of the first image data to the second resolution of the second image data and outputting the second image data for performing the image processing.

According to the present embodiment, as an effect, light receiving element arrays different in pixel pitch can be each used in an image reading device without redesigning an optical system.

Aspects of the present embodiment are, for example, as follows.

### Aspect 1

According to Aspect 1, an image reading device includes: a light receiving element array including multiple light receiving elements arrayed in a main scanning direction, the multiple light receiving elements each corresponding to a pixel, the multiple light receiving elements being each to perform photoelectric conversion; multiple analog-to-digital (AD) conversion units provided one-to-one to the multiple light receiving elements, the multiple AD conversion units being to convert respective pieces of analog data photoelectrically converted by the multiple light receiving elements to digital data in parallel; a conversion output unit to convert the digital data converted in parallel by the multiple AD conversion units to image data as serial data in the main scanning direction and output the image data; and a resolution conversion unit to convert a resolution of the image data output by the conversion output unit, the resolution conversion unit being to convert the resolution of the image data to a predetermined resolution corresponding to the light receiving element array.

### Aspect 2

According to Aspect 2, the image reading device of Aspect 1 further includes an output control unit to control an output start pixel and an output end pixel of the image data in the main scanning direction changeably, the image data being output by the conversion output unit, in which the conversion output unit reads the digital data, based on the output start pixel and the output end pixel controlled by the output control unit.

### Aspect 3

According to Aspect 3, the image reading device of Aspect 1 or 2 further includes a light receiving element board on which the light receiving element array and the multiple AD conversion units are mounted, in which the resolution conversion unit is provided to the light receiving element board.

### Aspect 4

According to Aspect 4, the image reading device of Aspect 1 or 2 further includes an image processing board to perform image processing to the image data of which the resolution is converted by the resolution conversion unit, in which the resolution conversion unit is provided to the image processing board.

### Aspect 5

According to Aspect 5, the image reading device of any one of Aspects 1 to 4 further includes a parameter setting unit to set a resolution conversion parameter for the resolution conversion unit, in which the resolution conversion unit converts the resolution of the image data, based on the parameter set by the parameter setting unit.

### Aspect 6

According to Aspect 6, the image reading device of Aspect 2 further includes: a period change unit to change, based on the output start pixel and the output end pixel controlled by the output control unit, a period with which the conversion output unit converts the digital data to the serial data in the main scanning direction in accordance; and a reading line-speed change unit to change, in accordance with the period changed by the period change unit, a reading line speed at which each of the multiple light receiving elements photoelectrically converts respective beams of light from different positions in a sub-scanning direction, successively.

### Aspect 7

According to Aspect 7, the image reading device of Aspect 6 further includes: a light source to irradiate an original document; and an adjusting unit to adjust an amount of light of the light source in accordance with the period changed by the period change unit.

### Aspect 8

According to Aspect 8, an image forming apparatus includes the image reading device of any one of Aspects 1 to 7.

### Aspect 9

According to Aspect 9, an image reading method to be performed by an image reading device includes: converting respective pieces of analog data from photoelectric conversion by multiple light receiving elements that is arrayed in a main scanning direction in a light receiving element array and each corresponds to a pixel to digital data in parallel by multiple analog-to-digital (AD) conversion units provided one-to-one to the multiple light receiving elements; converting the digital data converted in parallel by the multiple AD conversion units to image data as serial data in the main scanning direction and outputting the image data; and converting a resolution of the image data read to a predetermined resolution corresponding to the light receiving element array.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An image reading device comprising:
a light receiving array including multiple light receiving elements arrayed in a main scanning direction, the multiple light receiving elements to perform photoelectrical conversion for corresponding pixels and output analog data, respectively;
multiple analog-to-digital converters to respectively convert the analog data converted by the multiple light receiving elements to digital data in parallel form;
circuitry configured to convert the digital data in parallel form converted by the multiple analog-to-digital converters to first image data in serial form in the main scanning direction and output the first image data having a first resolution; and
an image processor to perform an image processing to second image data having a second resolution different from the first resolution,
wherein the circuitry is further configured to convert the first resolution of the first image data to the second resolution of the second image data and output the second image data to the image processor.

2. The image reading device according to claim 1, wherein the circuitry is further configured to:
change an output start pixel and an output end pixel of the first image data in the serial form in the main scanning direction according to the image processing performed by the image processor; and
read the digital data in the parallel form based on the output start pixel and the output end pixel changed according to the image processing.

3. The image reading device according to claim 1, further comprising a light receiving element board including:
the light receiving array;
the multiple analog-to-digital converters; and
the circuitry,
on the light receiving element board.

4. The image reading device according to claim 1, further comprising an image processing board including:
the image processor; and
the circuitry configured to convert the first resolution of the first image data to the second resolution of the second image data and output the second image data to the image processor.

5. The image reading device according to claim 1, wherein the circuitry is further configured to:
set a resolution conversion parameter to convert the first resolution to the second resolution; and
convert the first resolution of the first image data to the second resolution of the second image data, based on the resolution conversion parameter.

6. The image reading device according to claim 2,
wherein the circuitry is further configured to:
convert the digital data in the parallel form to the first image data in the serial form in the main scanning direction at a first period;
change the first period to a second period different from the first period based on the output start pixel and the output end pixel; and
control each of the multiple light receiving elements to photoelectrically convert respective beams of light from different positions in a sub-scanning direction orthogonal to the main scanning direction at a first reading line speed; and
change the first reading line speed to a second reading line speed different from the first reading line speed according to a change from the first period to the second period.

7. The image reading device according to claim 6, further comprising:
a light source to irradiate an original document with a first light amount; and
the circuitry further configured to control the light source to change the first light amount to a second light amount different from, the first light amount according to the change from the first period to the second period.

8. An image forming apparatus comprising
the image reading device according to claim 1 to read image on an original document; and
an image former to form an image on a medium based on the image read by the image reading device.

9. An image reading method comprising:
performing photoelectrical conversion for corresponding pixels and output analog data, respectively, by multiple light receiving elements arrayed in a main scanning direction;
respectively converting the analog data to digital data in parallel form;
converting the digital data in parallel form to first image data in serial form in the main scanning direction and outputting the first image data having a first resolution;
performing an image processing to second image data having a second resolution different from the first resolution; and
converting the first resolution of the first image data to the second resolution of the second image data and outputting the second image data for performing the image processing.
